(19) United States
(12) Patent Application Publication
(10) Pub. No.: US 2018/0066419 A1
(43) Pub. Date: Mar. 8, 2018

(54) SYSTEM AND METHOD FOR PRODUCING POTABLE WATER FROM STORMWATER

(71) Applicants: Cory ALBERS, Calgary (CA); Bernard AMELL, Calgary (CA)

(72) Inventors: Cory ALBERS, Calgary (CA); Bernard AMELL, Calgary (CA)

(21) Appl. No.: 15/686,539

(22) Filed: Aug. 25, 2017

Related U.S. Application Data
(60) Provisional application No. 62/384,033, filed on Sep. 6, 2016.

(51) Int. Cl. E03B 3/02; C02F 1/00; C02F 1/44

(52) U.S. Cl. CPC E03B 3/02; C02F 2103/001; C02F 1/441; C02F 1/004

(57) ABSTRACT

Stormponds provide a secondary source of non-potable water within a community that can be treated within the community to remove contaminants, rather than at a regional water treatment plant which provides a primary potable water supply to the community. The treated stormwater provides a secondary supply of potable water to assist in meeting the potable water demand of the community. To address issues of public trust in the potable water supply, the secondary potable water supply is tested and compared to test data from the primary potable water to direct further treatment of the secondary potable water to address secondary considerations therein, such as a taste-profile, an odor-profile, a hardness of the water, pH and reactivity. The secondary potable water is treated accordingly to adjust the secondary considerations to be substantially the same as the primary potable water.

### CROSS-REFERENCE TO RELATED APPLICATIONS

This application claims the benefit of U.S. Provisional Patent Application Ser. No. 62/384,033, filed on Sep. 6, 2016, the entirety of which is incorporated herein by reference.

### FIELD

Embodiments disclosed herein are related to systems for use of stormwater runoff from an urban or industrial environment and, more particularly, for use as a source of non-potable water for production of potable water within a community for use by one or more communities, or other users, of a high quality, aesthetically acceptable water.

### BACKGROUND

It is well known in the art of potable water treatment that source water for a potable water treatment system can be obtained from water that is stored in a waterbody such as a lake, from water flowing in a river, or from groundwater wells. Lakes or rivers may be supplied from direct stormwater runoff from the landscape or from indirect runoff as groundwater systems discharge into a receiving water body.

Operating public water utility infrastructure involves a great deal of public trust. For potable water treatment in large municipal centres, regional water treatment plants (WTP) are constructed to provide service to the general population of residential and commercial users. It is typical to construct water treatment plants at a single location to service populations of hundreds of thousands or more residents. Beyond constructing the regional potable water treatment plants, regional potable water transmission systems are required to convey large flow rates of treated potable water to customers who may be many tens of kilometres away or more. Multiple regional water treatment plants may be required to service very large populations where each WTP generally services its own set of customers with little to no mixing of the two water systems other than to provide some relatively low volume balancing water transfer services if there are major shutdowns in one or more of the WTP systems.

One of skill in the art would understand that it would be challenging to use multiple different water sources, where each water source may have different water chemistry properties, such as hardness and pH, as well as taste and odor profiles, to supply a single potable water network. However, there are instances where such an approach is necessary, such as may be the case in dry coastal areas where one potable WTP may draw water from a freshwater source while another one or more WTPs may draw water from a marine environment and use desalination systems to create freshwater. In such cases, potable water produced from each WTP is typically combined at the upstream end of a regional potable water distribution network so that the two or more water streams may thoroughly mix prior to being delivered to customers.

As one of skill in the art would understand, small scale potable water treatment systems, sometimes known as packaged water treatment plants, are used extensively to provide potable water for industrial work camps, small municipalities, first nations communities and other relatively small scale end use cases. Packaged water treatment plants are convenient as they may be shipped on a truck as an integrated unit with all the design and engineering completed and all plumbing, electrical, control and monitoring systems intact and ready to use at the destination.

A packaged water treatment plant can be thought of as an off-the-shelf system that can range in size from the very small, such as may be installed under the sink in a home, delivering tens of litres of potable water per day, to large systems, such as may take up the entire space within a large truck trailer with the capability of delivering 5,000 m³ of potable water per day or more. There are many different water treatment technologies that could be used within a packaged WTP, including but not limited to membranes, fabric or porous media filters, reverse osmosis, chemical treatments and the like. Packaged WTPs are not typically used in regional WTPs that deliver water to regional potable water distribution networks because packaged WTPs are designed for applications where space constraints and an all-in-one design is desirable. Mobile and semi-mobile applications using packaged WTPs are known. Different design approaches are desirable for regional WTPs where daily treatment volumes can be in the range of tens of thousands to millions of cubic metres and an all-in-one design or mobility are of little or no value.

As one of skill in the art would understand, packaged WTPs can be used in series, where it may be common to mix treatment technologies, as may be the case if using a prefiltration system upstream from a more sensitive reverse osmosis system, to reduce the potential for fouling of the more sensitive system. Alternatively, or additionally, packaged WTPs can be used in parallel, where each of the systems in parallel would typically, but not necessarily, employ the same water treatment technology, as may be the case if using two or more packaged WTPs to provide a higher treatment flow rate than could be provided by a single system. Further, drawing water for input to a packaged WTP from a high quality source of raw water is beneficial in reducing the operations and maintenance cost of producing potable water.

It is typical for a packaged WTP, drawing water from a single raw water source, to provide the potable water needs for an entire potable water distribution system. As a result, the water chemistry delivered to the potable water distribution system by a packaged WTP will be influenced by the original source water, such as may be the case, for example, if the source water consists of hard or soft water, and by the treatment technology specifically employed in the packaged WTP.

Delivering water from two packaged WTP systems at different locations, each drawing water from sources with significantly dissimilar water chemistry, to the same distribution system is rarely done without considerable care taken to functionally separate the distribution system into parts. This is because incomplete mixing of two water supplies with different water chemistry can lead to aesthetic problems such as inconsistent odour and taste with corresponding rapid changes in water properties, such as hardness. Inconsistencies and/or rapid changes in aesthetic properties may cause users concern that, for example the amount of soap required to complete a washing task changes rapidly and without warning. Even if the changing aesthetic properties are not offensive in absolute terms and the water is technically safe for human consumption, rapid changes in perceived water properties that occur without warning are alarming to users, and thus, can erode faith in the safety of the potable water system. Technical and health related problems can also arise where water produced by one packaged WTP may have a more chemically-reactive water chemistry profile than the other packaged WTP. Penetration of more chemically-reactive water into a portion of the potable water distribution system normally supplied by less chemically-reactive water may result in leaching of resident constituents in the system that otherwise were in equilibrium with the less chemically-reactive water.

As one of skill in the art of stormwater management would understand, it is typical for municipal development to take place by expansion of the land area within the municipal boundary, unless there are obstacles such as waterbodies, mountains or the like that would preclude such municipal boundary expansion. Municipal boundary expansion is often associated with the creation of new suburbs and community developments. Municipal planning professionals may be tasked with setting aside utility corridor rights-of-way that would support growth projections decades into the future, but ongoing municipal development will eventually exceed the time horizon of even the best laid plans. Major utility infrastructure, such as regional potable water supply conduits, may be constructed to support the anticipated population increase within a service boundary over a time horizon of 20 years or so. Municipal development exceeding the planning time horizon, or the anticipated population growth, may need to be supported by expensive and inconvenient upgrades to existing infrastructure or through the construction of new infrastructure in unused or new utility corridor rights-of-way.

It has been common practice, since about 1980, in North American municipal environments such as a large city, to include a stormwater pond (known by many other terms of art, but referred to herein as a stormpond as described below) as a part of a community development. The introduction of stormponds was a very successful direct response to the real and profoundly difficult problem of supporting municipal development well beyond the original planning time horizon of regional stormwater drainage utility infrastructure.

A stormpond provides temporary water storage by receiving high intensity stormwater runoff from the community and gradually releasing the stored water over time. Temporary water storage provided by the stormpond reduces the peak runoff from the community to regional stormwater drainage infrastructure, such as constructed or natural channels and regional stormwater drainage trunk conduits. Reducing the peak runoff flow rate from each community means that the regional stormwater drainage infrastructure is less operationally stressed, thus enabling continued community development without requiring major drainage infrastructure capacity upgrades. Some older communities originally constructed without a stormpond may be retrofit with a stormpond or a stormpond retrofit may be constructed at a convenient location on a regional stormwater collection network to provide stormwater peak flow attenuation and/or water quality improvement service to urban catchment areas.

For purposes herein, the word “regional” is intended to mean on the scale of a city or a municipal region that may or may not be composed of a plurality of municipal corporate entities. Typically, regional utility infrastructure would not provide utility service to any one property, but would instead provide utility service to a community where it is the community utility infrastructure that provides utility service to individual properties.

For the purposes herein, the word “community” means a discrete development area, which may consist of residential or commercial land uses or a combination of land uses. A community may encompass a one or more municipal corporate entities or may represent a portion of a larger municipal corporate entity.

The words “regional” and “community” may be replaced with other terms of art that represent similar intended meaning from the definitions presented herein.

As municipal environments expand, new community developments are created that may range in area from tens to thousands of hectares (ha) in area and may service populations ranging from hundreds of people to tens of thousands of people, or more. One of skill in the art would understand that a community may or may not have its own stormpond or a community may be built as a part of a larger development area where many communities discharge to a single stormpond. A community may also have more than one stormpond.

Communities often, but do not necessarily, have similar boundaries for their community potable water distribution, their community sanitary water collection and their community stormwater collection networks. For simplicity, Applicant has referred herein to a community, where the community water utility systems of potable water, sanitary wastewater and the stormwater are within the same approximate boundary and where each of the three community water utility systems are serviced by a corresponding regional water utility system. As one of skill would appreciate, the principles taught herein apply to communities where the boundaries of the potable water distribution network, the sanitary collection network and the stormwater collection network do not have the same approximate boundaries.

Stormponds typically function by fluctuating a water surface elevation (WSE) in response to stormwater inflows from a normal water level (NWL) to a high water level (HWL). The difference in water storage between the NWL and the HWL represents an active storage volume for the pond, which one of skill in the art may choose, to contain some design target stormwater runoff event volume associated with a high intensity storm, a long duration storm or some combination thereof. Water stored below the NWL is commonly referred to as dead or permanent storage, being a typical minimum water storage volume in the pond. The NWL is typically controlled by an outlet control structure with a weir, an orifice, an outlet pipe or a combination of these or other elements with a configuration such that water is actively conveyed away from the pond so the water level in the storm pond falls until it reaches the NWL.

The storm pond in each community may provide drainage from an area that may be sparsely populated or may be populated by tens of thousands of residents or more. Cities can grow by adding communities and may have hundreds of stormponds within their municipal boundaries. Utility pipe infrastructure must be constructed within each community for delivering potable water to each client, removing sanitary water from each client and removing stormwater from roadways, parking lots and other areas within the community. As communities are added to the municipality, the load on regional utility infrastructure, such as major potable water mains, major sanitary sewer trunk pipes and major stormwater conveyance infrastructure, increases.

As one of skill in the art would understand, land development creates impervious surfaces from what was formally an undeveloped environment, containing vegetation and permeable soils. Such a post-development change in the land surface permeability results in increased stormwater runoff flow rates and volumes from developed environments compared to the respective predeveloped environments. Excess stormwater runoff generated by widespread land development activities may be difficult to manage effectively without causing lasting damage to sensitive receiving environments, such as small creeks or irrigation canals, which may form all or part of a regional stormwater conveyance network. Prior art stormwater management practices typically result in more than about 50% of the post-development annual precipitation flowing into a storm pond as runoff and ultimately delivered to a receiving water body, such as a river. In contrast, pre-development runoff to the same river was typically in the range of about 5% to about 10% of the annual precipitation volume. There are land development scenarios where it is desirable, and in some cases essential, for the post-development runoff to equal pre-development runoff.

Stormponds can only go so far toward reducing the peak stormwater runoff flow rate when discharging to a sensitive receiving environment, thus stormwater runoff volume reduction strategies may also be required. As one of skill in the art would understand, volume reduction strategies may involve creating absorbent landscapes, infiltration inducing infrastructure or other techniques that serve as stormwater volume source control measures, thereby intercepting stormwater prior to the stormwater reaching the stormpond. These measures can be thought of as attempting to bring back some of the former absorbency of the landscape prior to urban development and may include plant communities that consume and release water to the atmosphere through evapotranspiration.

Stormwater volume reduction strategies are known by many names, but are commonly referred to as low impact development (LID) practices, where the intention is to come as close as possible to generating post-development stormwater runoff flow rates and volumes that are approximately equal to the pre-development stormwater runoff flow rates and volumes. Other stormwater runoff volume reduction strategies include reusing stormwater to irrigate public spaces, such as parks and golf courses. While stormwater source control measures such as absorbant landscapes and stormwater reuse irrigation are undoubtedly an effective means of reducing stormwater runoff flow rates and volumes, such strategies are very expensive to construct at the scales required to realistically match post-development and pre-development stormwater runoff flow rates and volumes. Furthermore, implementing stormwater reuse irrigation strategies may require installation of dedicated and expensive utility pipes and pump stations, while potentially, during irrigation, exposing the public to health risks from pathogens that may be resident in the stormwater pond, unless considerable and potentially expensive water treatment measures have been implemented to protect public health.

By way of example for illustrating the potential cost of implementing the prior art stormwater volume reduction practices, depending on construction practices and materials used, it may cost more than about $800,000 per hectare (ha) of land and could require construction of absorbent landscapes on about 10% of the community land area. For a relatively small community with about 100 ha of land, and perhaps no more than about 5000 residents, the prior art practices represent a capital construction cost of about $8 million. The prior art practices also require maintenance activities every year, which may cost somewhere in the range of about 5% to about 10% of the capital cost annually. Over a 25 year life cycle, prior art practices may result in a total expenditure in excess of about $20 million per 100 ha community to deploy large scale absorbent landscape practices and there may be hundreds or even thousands of communities in a large metropolitan area. Implementing stormwater irrigation reuse for the same small community with about 100 ha of land could similarly generate costs over a 25 year life cycle ranging from millions of dollars to tens of millions of dollars, depending on the extent of constructing a stormwater reuse utility pipe network.

The above-described, prior art stormwater volume reduction practices are intended to induce a low impact on sensitive waterbodies and/or regional stormwater conveyance infrastructure systems that receive stormwater runoff. However, these prior art practices can, ironically, have a relatively high impact on the available water to downstream users since such practices tend to create landscapes that demand water. LID design practices often use drought tolerant plant species however, even drought tolerant species may be stressed and die during a prolonged drought without some form of irrigation intervention. Communities and private developments containing LID environments may be highly motivated to irrigate the environments during a prolonged drought simply to protect the investment in living plant systems. It is precisely at these times of prolonged drought that the water bodies, serving as raw source water for the community potable water supply, are most vulnerable. Prolonged droughts may be rare, however they do happen and there are ample examples around the world where prolonged droughts cause havoc in communities.

While it may be possible to enable the post-development stormwater runoff volume from the landscape to equal the pre-development runoff volume, a total water balance for each community must also include the potable water and sanitary water systems. The potable and sanitary water systems are out of balance between the pre and post-development conditions because not all of the potable water delivered to a community is typically returned as sanitary water. This means that any community that is added to a municipal area, where the community in question generates post-development stormwater runoff volume equal to pre-development stormwater runoff volume, may be a net consumer of water. In arid climates, or other environments where competition for water resources is fierce, strategies that systemically create net consumption of water should be avoided. In such cases where water bodies are under stress of having too many annual water withdrawal demands, the water bodies that support the community by supplying potable source water and receiving stormwater runoff and treated wastewater discharges are more likely to benefit from excess stormwater runoff.

Most stormponds that have been constructed prior to 2010 were designed purely for the purposes of providing active volume storage and attenuation of peak flow discharging to downstream receiving environments. In more recent years, stormponds have been viewed as systems that could also serve to provide stormwater treatment services, so as to improve the quality of stormwater both in a stormpond and thus, the quality of water discharged from the stormpond to downstream receiving environments. An example of one such effort to enable some form of stormwater quality treatment, while reducing the cost of maintaining a stormwater pond, is described in Applicant's issued U.S. Pat. No. 8,333,895, and known as a NAUTILUS POND®.

Water is the most precious resource for human society. Water security is an important component of public policy and can be a source of profound conflict in locations where there is strong competition for scarce water resources.

Such conflict intensifies at times of drought, or if there is a long term trend reducing the availability of water. Overuse of water for farming, or for the creation of unsustainably water consuming landscapes in arid climates, has drained aquifers, resulting in community shock when there is reduced supply, or simply no more water available. Growing communities will demand more water over time as a result of population increases and from expansion of industry. The future security of water supply to communities may be threatened to greater or lesser degrees by changes to the hydrologic cycle due to long term natural and anthropogenic climate change.

Communities and industries can greatly benefit from implementing systems that either temporarily or permanently draw water from sources other than a single or a small number of major water diversion locations.

There is great interest in systems and methods for meeting the increasing demands for potable water, while maintaining faith by end users thereof that the systems continue to provide a safe supply of potable water. Further, there is great public benefit in finding a way to safely use excess stormwater, generated by urban landscapes, such as to reduce conventional or primary potable water consumption, rather than creating living plant systems simply to consume and evapotranspire water.

### SUMMARY

Embodiments taught herein disclose use of stormwater collected within a community stormpond for treatment, in the community, to provide a secondary source of potable water. Unlike conventional systems which typically draw water from only a single source for delivery to one or more communities, the secondary source of potable water produced according to embodiments taught herein can be used along with a primary source of potable water, to meet the potable water demand in the one or more communities. The primary source of potable water is typically produced by a regional water treatment plant, which draws non-potable water from one or more water bodies, such as a river or lake within a watershed.

Embodiments taught herein treat the stormwater from the stormpond locally within the community using a community water treatment plant which comprises one or more treatment modules to remove primary contaminants for producing the secondary potable water. Further, the secondary potable water is treated to address secondary considerations such as a taste-profile, an odor-profile, a hardness of the water, pH and reactivity to be substantially the same as in the primary potable water supply. Testing is performed on the primary and secondary potable water supplies to determine the difference therebetween and to direct the additional treatment of the secondary potable water to address the differences.

In one broad aspect, a potable water supply system for delivering potable water to at least one community, the at least one community having a primary potable water supply and access to at least one stormpond and non-potable water collected therein, comprises a community water treatment system for treating at least a portion of the non-potable water from the stormpond for removing primary contaminants therefrom for producing a secondary potable water supply for delivery to the at least one community.

The potable water supply system further comprises one or more primary water analysis systems for determining at least secondary considerations of the primary potable water supply and one or more secondary water analysis systems for determining at least secondary considerations of the secondary potable water supply. At least one balancing unit is used to further treat the secondary potable water supply to adjust the secondary considerations to be substantially the same as the secondary considerations in the primary potable water supply.

In another broad aspect a method for supplying potable water to at least one community, the at least one community having a primary potable water supply and access to at least one storm pond and non-potable water collected therein, comprises: analyzing the primary potable water supply for determining at least secondary considerations therein. At least a portion of the non-potable water from the storm pond is treated for producing a secondary potable water supply. The secondary potable water supply is analyzed for determining at least secondary considerations. The secondary potable water supply is treated to adjust the secondary considerations to be substantially the same as the secondary considerations in the primary potable water supply.

In yet another broad aspect, a system for supplying a demand for potable water by one or more communities accessing a watershed for supplying a primary source of non-potable water for producing a primary potable water in a regional water treatment plant, the one or more communities having access to a stormwater pond collecting non-potable runoff water from at least one of the one or more communities therein, comprises: drawing at least a portion of the secondary non-potable runoff water from the storm pond as a secondary source of non-potable water. The at least a portion of the secondary non-potable runoff water is treated in a community water treatment system to produce secondary potable water. The secondary potable water is supplied to the one or more communities. While supplying the secondary potable water, draw volume of primary non-potable water from the primary water source to the regional water treatment plant is decreased. At least a portion of the secondary potable water is released to the watershed after use by the one or more communities; and a volume of the non-potable run-off from the stormpond is released to the watershed at or below a threshold volume and at a rate to avoid damage thereto. The decrease in the draw volume from the primary water source, the at least a portion of the volume of the secondary potable water released to the watershed after use and the volume of non-potable water released from the stormpond to the watershed results in from a zero to net surplus of water in the watershed.

In embodiments, the threshold volume is a pre-development volume.

### BRIEF DESCRIPTION OF T H E DRAWINGS

FIG. 1A is a schematic, illustrating a prior art water infrastructure in a community within a large municipality having separately functioning regional and community water utility infrastructure;

FIG. 1B is a schematic illustrating an embodiment taught herein, the prior art water infrastructure of FIG. 1A further comprising a community water treatment system functioning within the community infrastructure for providing a supplemental means of producing potable water according to embodiments taught herein, from a secondary source of non-potable water obtained from a stormwater pond;

FIG. 2A is a plan view of a stormwater pond outlet system, according to an embodiment disclosed herein, having a community water treatment system drawing water from the stormpond and a prior art stormpond outlet and outlet control structure;

FIG. 2B is a cross section view according to FIG. 2A;

FIG. 2C is a plan view pf a stormwater pond outlet system according to an embodiment disclosed herein wherein a portion of the stormwater pond is isolated or semi-isolated from a main stormwater pond area;

FIG. 2D is a cross-sectional view according to FIG. 2C; and

FIG. 3 is a schematic illustrating the community water treatment system of FIG. 2A having multiple water treatment plant modules and water chemistry analysis and balancing equipment.

### DETAILED DESCRIPTION

Embodiments taught herein utilize stormwater, collected and stored in stormwater ponds within or adjacent communities, to provide a secondary source of water from which potable water can be produced within the community. Potable water produced from the stormwater is distributed to the community users, to supplement or temporarily replace regionally produced potable water, using existing infrastructure, or in the case of new communities, the same infrastructure being installed for existing purposes. Thus, the need for costly upgrades or redundancy of infrastructure can be minimized or eliminated.

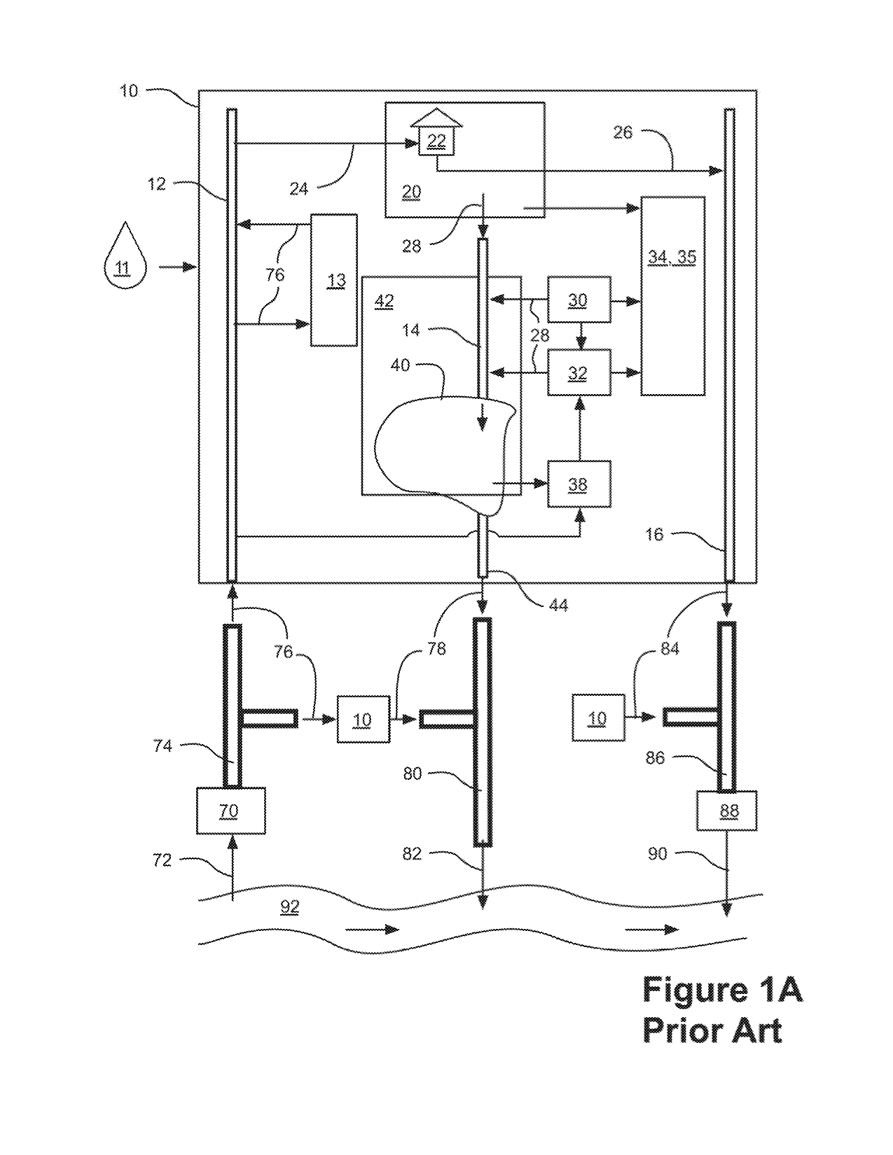

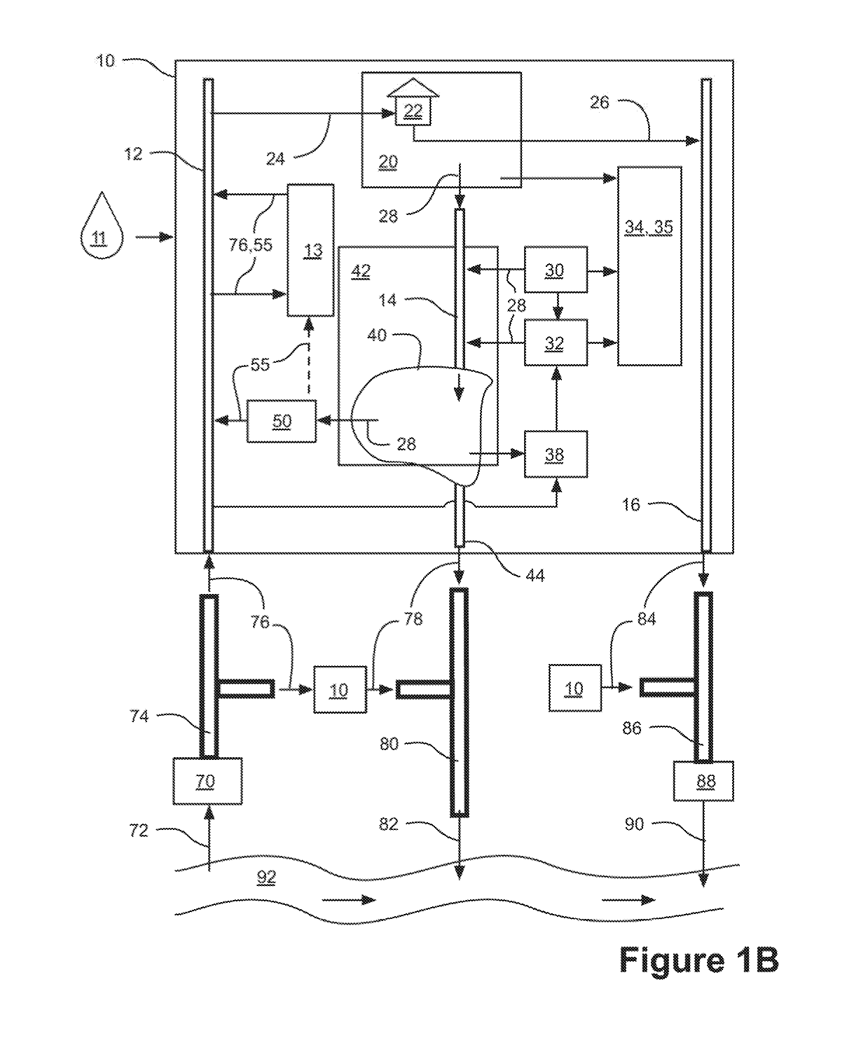

FIG. 1A schematically illustrates prior art water service infrastructure for a community 10 within a municipality or municipal region. Precipitation 11 falls on the community 10, generally comprising privately or publicly owned properties 20 that may or may not contain buildings 22, community hard spaces 30, such as parking lots and roads and community soft spaces 32, such as parks and natural areas.

Communities 10, built in the past 30 to 40 years, typically have access to one or more stormponds 40, generally located within the community 10, that receive runoff water 78 from a community stormwater collection system 14 prior to discharging the water 78, via an existing stormpond outlet 44, to a regional stormwater conveyance network 80, which typically discharges to one or more water bodies 92, such as a river, within a watershed.

A regional water treatment plant (WTP) 70 produces a supply of primary potable water 76 by treating non-potable water drawn from one of the one or more water bodies 92. The WTP 70 supplies a regional potable water distribution network 74 with the primary potable water supply 76, which is then delivered to a community potable water distribution network 12. The community potable water distribution network 12 delivers potable water 24 to one or more buildings 22 within the community 10.

Potable water storage reservoirs 13 may be located within or outside the community 10 and may be connected to the community potable water distribution network 12, or may be connected to the regional potable water distribution network 74 to provide distributed primary potable water storage. Upon using primary potable water 76 by an end user, such as in a building 22, wastewater 26 is delivered to the community sanitary sewer network 16 before being delivered 84 to a regional sanitary sewer conveyance network 86 and to a regional waste water treatment plant (WTP) 88 that ultimately discharges 90 treated wastewater to the one or more water bodies 92.

The precipitation 11 that falls within the community 10 flows as runoff 28 from properties 20, community hard spaces 30 and community soft spaces 32, but a portion of the precipitation 11 is lost to the atmosphere 34 and groundwater 35. Some runoff or stormwater 28 from community hard spaces 30 may be delivered to community soft spaces 32. Local irrigation systems, using potable water 24 or by reusing some of the stormwater 28, may be operated on a property 20 that could generate runoff, evaporation, or flow into groundwater. Irrigation of community soft spaces 32 typically takes place through an irrigation system 38 that may be fed potable water directly from the community potable water network 12 or from stormwater contained in the community stormpond 40. Local irrigation of properties 30,32 can also take place by intercepting and reusing runoff 28 prior to discharging to a community stormwater collection system 14.

Stormwater quality within a stormpond 40 may vary considerably in response to a storm event if stormwater quality improvement means 42 are not implemented. One of skill in the art would understand there are a plurality of stormwater quality improvement means available including, but not limited to oil-grit separator systems, embodiments of Applicants' NAUTILUS POND®, biofiltration systems such as bioswales and wetlands, or direct filtration systems such as sand, fabric or membrane filters. Typically, one of skill in the art would determine whether to construct any one or a combination of these stormwater quality improvement means on a property 20, within the community stormwater collection network 14 or in a stormpond 40. There is value in implementing one or more embodiments of the stormwater quality improvement means 42, such as those listed above, but in particular if there is a desire to reuse stormwater 28 for delivery to an irrigation system 38.

Further, Applicant believes implementing stormwater quality improvement means 42 may be advantageous in implementing and operating embodiments taught herein. The quality improvement means 42 permit drawing higher quality secondary source water 28 from the one or more stormponds 40 for the purpose of generating a secondary potable water supply 55, as described below.

The embodiment illustrated in FIG. 1B is structurally largely the same as the prior art system illustrated in FIG. 1B, with the exception of a community water treatment system 50 added to extract stormwater 28 from the storm pond 40 as the secondary non-potable water source for treatment thereof and ultimate delivery of the secondary potable water supply 55 to the community potable water distribution network 12. Secondary potable water 55 is delivered therein, either alone or mixed with primary potable water 76, for supplying potable water 24 to meet demand of the one or more communities served by the community potable water distribution network 12.

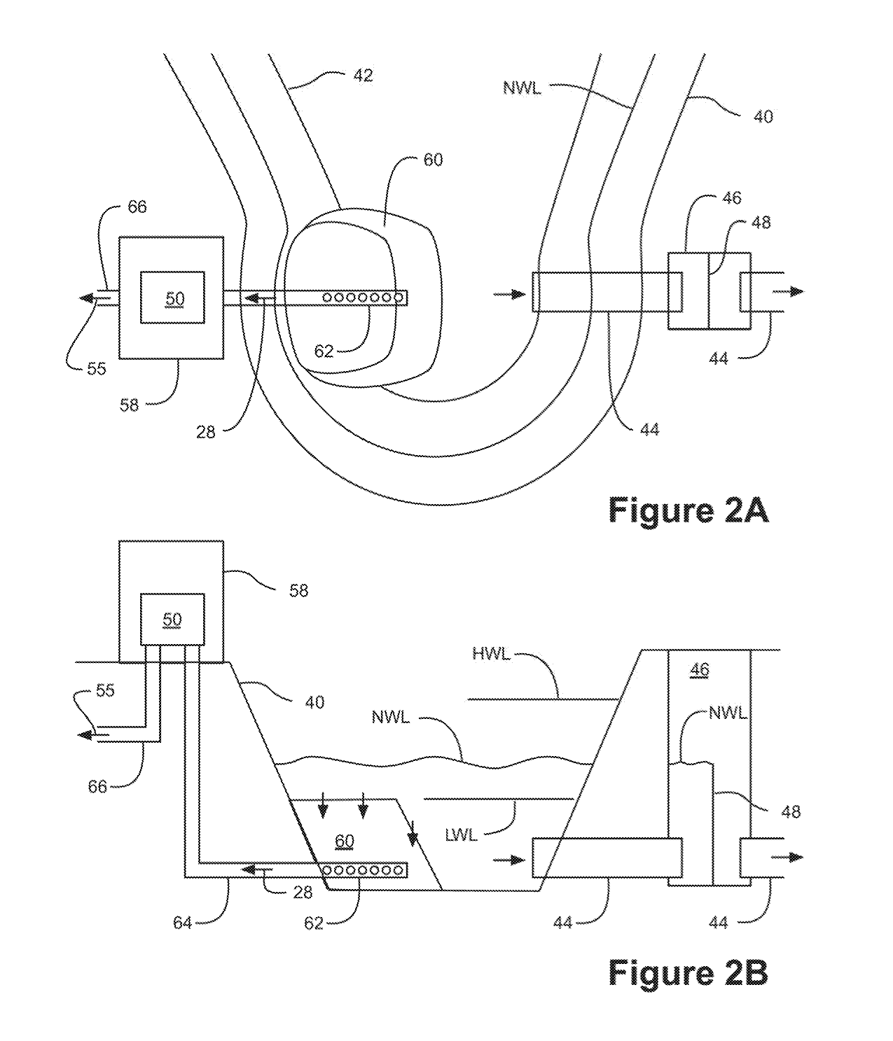

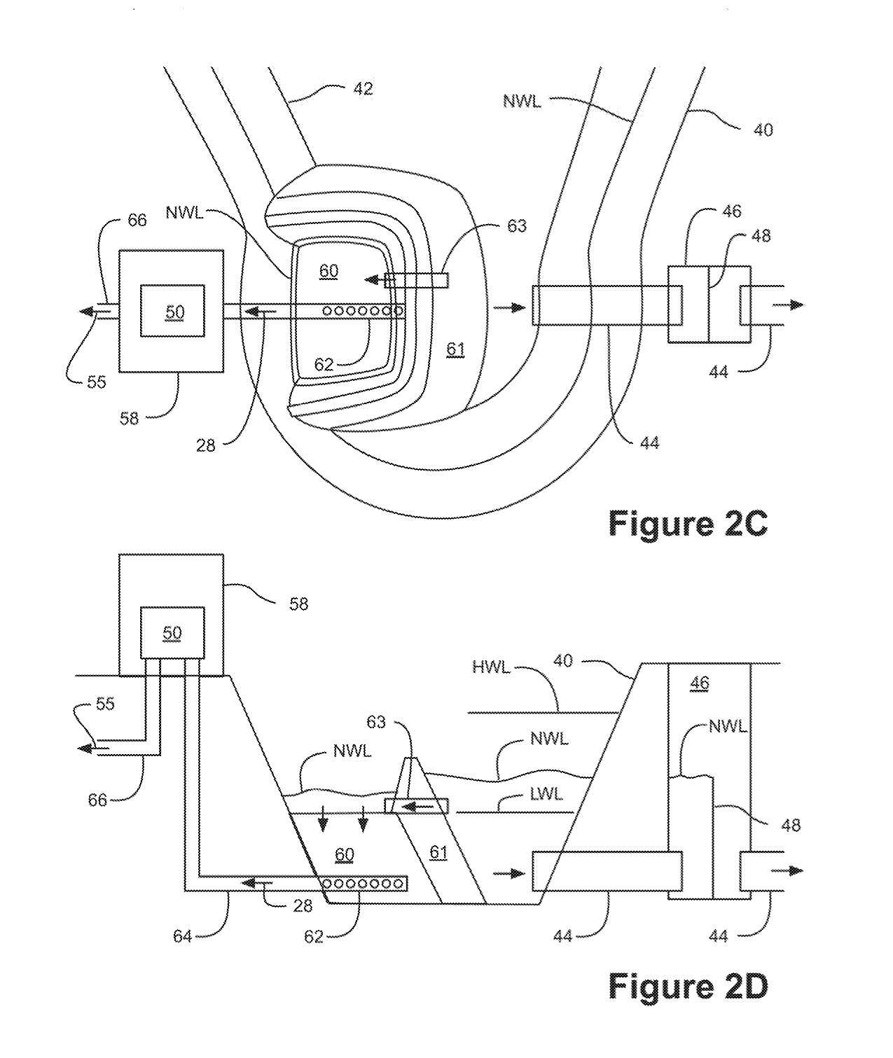

FIGS. 2A and 2B illustrate an embodiment of a system wherein the community water treatment system 50 is located near an existing stormpond outlet 44 from the community stormpond 40. Stormwater 28 is delivered to the community water treatment system 50, for producing a secondary potable water supply 55, through a granular filter bed 60, which is an embodiment of the stormwater quality improvement means 42. From the granular filter bed 60, stormwater 28 is conveyed through one or more perforated pipes 62 in the stormpond 40 that are fluidly connected to one or more non-perforated pipes 64 for delivering the stormwater 28 to the community water treatment system 50. For simplicity, pumps or other support infrastructure are not shown, however may be required, as one of skill in the art would understand.

Upon receiving one or more treatments at the community water treatment system 50, largely for removal of primary contaminants that affect the health and safety of the secondary potable water 55, the secondary potable water 55 is delivered safely, via a pipe 66, to the community potable water distribution network 12.

In an optional embodiment, as shown in FIG. 1B in dotted lines, the secondary potable water 55 can be delivered to one or more of the potable water storage reservoirs 13 for mixing with primary potable water 76, also delivered through the community potable water distribution network 12, before supplying 24 to the buildings 22.

The WSE in the stormpond 40 is typically controlled by the outlet control structure 46, which typically contains a control element 48, illustrated herein as a weir, or some other means to control the rate of flow and spill elevation from the stormpond 40. The NWL is typically controlled by the spill crest elevation of the control element 48 and represents the lowest WSE in the stormpond 40 where stormwater discharges through an existing stormpond outlet 44. The stormpond 40 provides active storage and outlet flow attenuation when the WSE varies between the NWL and the HWL. For a system configuration that reuses stormwater as a secondary non-potable water source for producing the secondary supply of potable water, embodiments of the community water treatment system 50 may be operational and drawing stormwater from the stormpond 40 until such time as the WSE in the stormpond 40 reaches a low water level (LWL). At the LWL, further operation of the community water treatment system 50 may be precluded.

FIGS. 2C and 2D illustrate an embodiment, respectively according to FIGS. 2A and 2B, where the granular filter bed 60 is enclosed by a berm 61 with water conveyed from pond 40 to the area enclosed by berm 61 via a flow conveyance element 63. Isolation or semi-isolation of the area enclosed by berm 61, relative to the remainder of the pond 40, enables beneficial operating modes where water from pond 40 is prevented from flowing through the flow conveyance element 63 as may be the case if the water quality in pond 40 is below a desirable threshold value or if the stormpond 40 has received unintentional or malicious inflows of some substance of concern. At a minimum, at least semi-isolation is achieved by the berm 61 having a height or crest above the NWL. Isolation of the area enclosed by the berm 61 is achieved by the berm 61 having the height or crest above the HWL.

The flow conveyance element 63 is illustrated in FIG. 2C and FIG. 2D as a pipe but one of skill in the art may elect to use an alternate means of conveying water from pond 40 that includes, but is not limited to a weir inside a control structure or over the berm 61 crest, a channel or a pump discharging through or over the berm 61. If the flow conveyance element 63 is a pump then the NWL in the area enclosed by berm 61 may be maintained above the NWL in pond 40. Appurtenances such as control or isolation valves and gates or backflow prevention may be included in the system design as may be deemed necessary by one of skill in the art. As illustrated in FIG. 2D, gravity flow from the stormpond 40 to the area enclosed by the berm 61 would typically result in a higher NWL in the pond 40.

In embodiments, one of skill in the art determines the appropriate size and geometry of the area enclosed by berm 61 and whether the berm 61 should be permeable, semi-permeable, impermeable or combinations thereof. The top elevation or height of the berm 61, illustrated in FIG. 2D as between the HWL and the NWL of stormpond 40, may be set higher than the HWL of stormpond 40 if deemed appropriate by one of skill in the art.

One of skill in the art would understand that granular filters may need backwashing to function successfully if the granular filters are small relative to the desired filter flow rate. Backwashing a granular filter located within the stormpond 40 may not be practical, thus, in embodiments, the granular filter bed 60 is of large enough area, such as may be the case if one were to draw about 10 L/s from a granular filter bed with an horizontal area of about 1000 m², to function like an aquifer layer that does not require backwashing. One of skill in the art would understand that the granular filter bed 60, as shown in any of FIGS. 2A, 2B, 2C or 2D, may serve as a foundation for soil structures that support a wetland, riparian or a combination of biological environments to provide enhanced water quality improvement benefits that such biological environments can provide. The granular filter bed 60 may also serve, intentionally or self-developing over time, as a biofilter with resident communities of microorganisms.

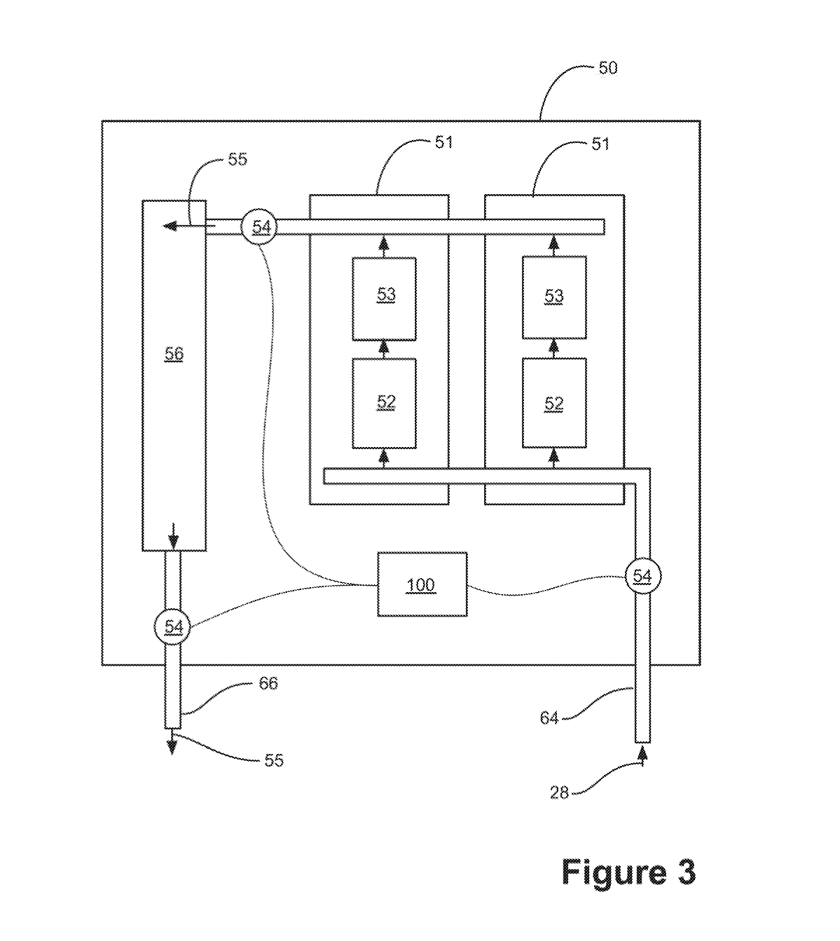

FIG. 3 illustrates an embodiment of a configuration of the community water treatment system 50. Infrastructure such as pumps, valves, control systems and other appurtenances are not shown for the sake of simplicity. Stormwater 28 drawn from the stormpond 40 through a pipe 64 is distributed to one or more treatment modules 51, each module 51 containing one or more potable water treatment elements 52,53 for producing potable water therefrom. An example configuration of one treatment module 51 comprises an upstream, pre-treatment water treatment element 52 with a downstream water treatment element 53, which may be a membrane system that enjoys operational benefits from the pre-treatment. For scenarios where the stormwater 28 delivered from stormpond 40 to the community water treatment system 50 is of high enough quality, minimal to no pre-treatment water treatment elements 52,53 may be required.

In embodiments, one of skill in the art establishes a water treatment objective and a design flow rate for each water treatment module 51. Further, a design consideration includes whether each of the one or more water treatment modules 51 need be composed of the same or different treatment technologies.

Multiple treatment modules 51 may be designed to operate in parallel and each water treatment module 51 may have a different design flow rate to enable a variable total community water treatment system 50 flow rate depending on the combination of online water treatment modules 51. Depending on the size and complexity of the community water treatment system 50, the community water treatment system 50, the water treatment module 51, or the water treatment elements 52,53 may be constructed and installed as packaged WTPs.

Since the primary non-potable source water, such as from the river 92, may be considerably different in composition, chemistry, or both compared to the secondary source water 28 in the stormpond 40, and the water treatment technologies in the regional WTP 70 may be different from the treatment modules and elements 51, 52, 53 in the community water treatment system 50, the water composition and/or chemistry of the primary potable water 76 delivered to the community potable water distribution system 12 could differ significantly from the secondary potable water 55 delivered from the community water treatment system 50.

As discussed above, the primary consideration of the community water treatment system 50 is necessarily to ensure that primary contaminants that affect the health and safety of the secondary potable water 55 delivered therefrom are removed. However, in embodiments taught herein secondary considerations, particularly with respect to one or more of a taste profile, a smell profile, a colour and/or the reactivity of the secondary potable water 55, are addressed to maintain community trust in the potable water 24 which may contain varying amounts of the secondary potable water supply 55 over time delivered from the community water treatment system 50.

In embodiments, the community water treatment system 50 is designed to deliver water 55 having taste and smell profiles, colour and reactivity that is substantially the same as that of the primary potable water 76 discharged from the WTP 70 to the regional potable water distribution network 74. By “substantially the same”, Applicant means that any variations therein are generally either imperceptible to the end user or are within a range that mimics normal fluctuations in taste, odor, color and reactivity in the primary potable water supply 76. If this is not done, the end users in the community 10, if subject to seemingly random changes in the condition of the delivered potable water 24, may believe that something is wrong with the potable water 24.

It is known that considerable research has been done in the field of water quality to identify the chemical causes of at least common tastes and odors in potable water, methods of identification and correlation to odor and taste profiles determined by sensory panels. A paper, “The Drinking Water Taste and Odor Wheel for the Millenium: Beyond Geosmin and 2-Methylisoborneol” by I. H. (Mel) Suffet et al., Water Science and Technology, Vol 40, Issue 6, 1999, pp 1-13, incorporated herein by reference in its entirety, describes examples of such research.

In embodiments, in order to maintain faith in the integrity of the water system, secondary water analysis systems 54 are placed at strategic locations for testing the composition, chemistry or both of the secondary potable water supply 55 delivered from the community water treatment system 50 to the community potable water distribution network 12. Similarly, primary water analysis systems 54 test the composition, chemistry or both of the primary potable water supply 76 discharged from the WTP 70.

In embodiments, at least a subset of secondary considerations are selected for testing using the water analysis systems 54. Selection of the subset may be based on a number of factors including, but not limited to, the composition, chemistry and aesthetics of the primary water source and primary potable water 76 produced by the regional WTP 70, the geological and geographical features in the one or more communities 10 that may affect the quality of the runoff water 28 stored in the stormpond 40, historical data regarding likely contaminants in the runoff water 28 and the like. Similarly, the treatment technologies available in the community WTP 50 are selected to address the most likely secondary considerations and contaminants for the one or more communities 10.

One or more water balancing units 56 are incorporated into the community water treatment plant 50 to address the secondary considerations of the secondary potable water 55 by adjusting a composition, a chemistry or both therein for a difference determined by comparison of the testing data from the water analysis systems for the primary and secondary potable water 76,55.

By way of example, if the primary potable water composition and/or chemistry discharged from the WTP 70 is consistent with a hard water source, but the water treatment module 51 in the community WTP 50 is based on reverse osmosis technology that creates soft water by stripping minerals, then the one or more balancing units 56 may be used to remineralize the water.

Similarly, the one or more balancing units 56 may be required to adjust the pH of the secondary potable water 55 supply to mimic the reactivity of the primary potable water supply 76. Additional steps, such as filtering, chemical treatment steps or the like, may be required to address taste-causing, odor-causing, coloured constituents or a combination thereof that are either present in or absent from the secondary potable water supply 55 when compared to the primary potable water supply 76 discharged from the WTP 70. The balancing units 56 are equipped to address at least the most likely of the secondary considerations that are being tested for.

A control system 100 receives data from the one or more water analysis systems 54 testing the secondary potable water supply 55 for comparison to the data received from the one or more water analysis systems 54 testing the primary potable water supply 76. The control system 100 determines the differences therebetween and instructs the various water treatment elements 52, 53 in the community WTP 50 and the balancing units 56, to control the function thereof to address the differences determined based upon the data received.

In embodiments, the control system 100 may include a processor, such as a CPU, for comparison of the data from water analysis systems 56. Further, the control system 100 may include data storage capability. Data can be transmitted from the water analysis systems 54 to the control system 100 and instructions delivered from the control system 100 to the balancing units 56 using wired connections or wireless communications.

Applicant believes the burden on the community water treatment system 50 to balance aesthetic secondary considerations is greater if the community water treatment system 50 discharges directly to the community potable water distribution network 12. A user building 22 that is located immediately adjacent the physical location where the community water treatment system 50 connects to the distribution network 12 may be exclusively supplied by the community water treatment system 50, simply due to proximity of connections. In this case, embodiments which address the secondary considerations are particularly useful in prevent alarm as a result of aesthetics that may change rapidly.

Alternatively, if the community water treatment system 50 discharges to potable water storage reservoirs 13 there is an opportunity to blend the secondary potable water 55 with the primary potable water 76 before delivering to any one user building 22. In this case, variations in the secondary considerations in the secondary potable water 55, exceeding a normal variation in the primary potable water 76 over time, may be less noticeable to the user as a result of the blending with primary potable water 76. In some cases, the aggregate aesthetic variation may fall within the normal variation.

The timing of stormwater withdrawal from stormpond 40 to the community water treatment system 50 depends on local climate conditions and the timing of water replenishing storm events to storm pond 40. Stormwater withdrawal might not be possible year round. Dry climates may only present the opportunity for a community water treatment system 50 to function during wet season months. Climates with winter conditions may enable limited community water treatment system 50 operations when the storm pond 40 is covered with ice.

By way of example, the potential community 10 source water storage for a 2 ha surface area stormpond 40 having about a 0.5 m difference between the NWL and the LWL is about 10,000 m³. A moderate sized packaged WTP, having the ability to produce approximately 1000 m³/day of potable water, would draw down the stormpond 40 from NWL to LWL in 10 days. Almost any storm event causing precipitation 11 on community 10 will deliver enough stormwater volume to raise the stormpond 40 WSE up to NWL, thus enabling operation of the community water treatment system 50 for at least many weeks, if not months, over the course of many storm events. The community water treatment system 50 can be designed to produce annual potable water volumes ranging from thousands to hundreds of thousands of cubic metres or more.

The benefits associated with embodiments disclosed herein are many and may generally be broken down into the four following categories:

benefits to the primary potable water supply;

benefits to the stormwater conveyance system;

benefits to community water balance; and

benefits to overall potable water supply resiliency.

Regarding benefits to the primary potable water supply, embodiments taught herein result in water treatment capacity and source water storage at the distal end of the regional potable water distribution network 74. The combination of remote water treatment capacity and source water storage, such as in the stormpond within the community, can result in a considerable reduction in the total annual water volume and peak flow rate conveyed to each community 10 by the regional potable water distribution network 74. The combination may enable deferral of major and very costly upgrades to the regional WTP 70 and the regional potable water distribution network 74 in favour of implementing many relatively low cost community water treatment systems 50.

The relatively low cost community water treatment systems 50 may be connected to the community potable water distribution network 12, such as through an about 200 mm diameter connector pipe 66 with a length measured in tens to hundreds of metres. By comparison, regional potable water distribution pipes 74 can be over 2.0 m in diameter with a length of many tens of kilometres to remote communities 10.

The combination of remote water treatment capacity and source water storage can also result in a considerable reduction in the potable water demand and thus, the operational stress on a regional WTP 70. Such operational stress might otherwise lead to boil water advisories, or other public safety breaches when the primary source water 72 quality is poor, as may be the case during a major seasonal flood of the primary source, such as a river 92.

Water storage represents another major benefit to the primary potable water supply since, for example, constructing a 10,000 m³ concrete water storage reservoir in a community 10 (i.e., equivalent to the storage volume in a 2 ha surface area stormpond 40 with a difference in WSE of about 0.5 m from NWL to LWL) would cost approximately $10 million, whereas a comparable level of community secondary source water storage is provided at essentially no extra cost by the existing stormpond 40.

One of skill in the art could assess the cost of the embodiments taught herein relative to upgrading the regional potable water treatment and delivery infrastructure. Applicants envision the embodiments would almost always generate more value for lower cost than upgrades to the regional potable water supply system.

Regarding benefits to the stormwater conveyance system, embodiments taught herein extract stormwater from the stormpond 40 prior to discharging to the stormpond outlet 44. The extraction of stormwater therefrom results in a reduction of the total stormwater volume and peak flow delivered 78 from the community 10 to the regional stormwater collection network 80.

Expensive and disruptive upgrades to the regional stormwater collection network 80 may be deferred as a result of implementing the embodiments. Furthermore, portions of the regional stormwater collection networks 80 may be composed of creeks and other potentially sensitive environments that would be harmed by excess runoff generated by urbanization.

Embodiments taught herein could be used to enable the stormwater runoff from the community 10 to be equal to the stormwater runoff 28 from the land before the community 10 was constructed. In fact, embodiments could also be retrofit into existing communities 10 to reduce a flow delivered 78 from the community 10 to the regional stormwater collection network 80.

Regarding benefits to the community water balance, urbanization creates a considerable increase in the impermeable land surface, which results in much greater stormwater runoff from community properties 20, community hard surfaces 30 and community soft surfaces 32 to the stormpond 40 than would be the case prior to constructing the community 10. Designers of a community 10 with strict sustainable development design goals may seek to match the post-construction community 10 stormwater runoff to the pre-construction stormwater runoff.

Prior art practices for reducing the stormwater volume and flow rate from the stormpond outlet 44 include LID practices and low quality stormwater reuse. LID practices typically decrease the amount of stormwater runoff from community hard surfaces 30 and community soft surfaces 32 by designing porous pavement systems, groundwater recharge systems, absorbent landscapes and the like, all of which are intended to increase the amount of community 10 stormwater lost to groundwater and the atmosphere 34, 35.

Low quality stormwater reuse is typically accomplished by drawing water from the stormpond 40 for delivery to a dedicated irrigation system 38 that irrigates community soft surfaces 32 and properties 20.

Prior art approaches to stormwater reuse may include something called a “purple pipe system”, which is a separate water delivery system similar in principle to the community potable water distribution network 12, but delivering water that has not been treated to a potable water standard. The use of such purple pipe water could be for irrigation, toilet flushing or other non-potable water uses.

Stormwater reuse for non-potable purposes is a technically viable way of reducing the stormwater flow rate and annual volume discharging from a stormpond 40 existing stormpond outlet 44, but a purple pipe utility has considerable capital cost, measured in millions of dollars for a 100 ha community 10, as well as maintenance costs. A purple pipe system also creates new demand for utility right-of-way land and utility crossing conflict costs, when other construction projects must cross the purple pipe utility right-of-way. Prior art practices for creating absorbent landscapes can cost more than about $10 million for construction and land acquisition within a 100 ha community 10.

Embodiments taught herein can achieve the same end goal of reducing the water volume and flow rate discharged 78 from a stormpond 40 to the regional stormwater collection network 80. Further, embodiments taught herein could enable zero discharge 78 from a stormpond 40 to the regional stormwater collection network 80, wherein all of the stormwater volume entering the stormpond 40 is directed from the stormpond 40 to the community water treatment plant 50.

Regarding benefits to water supply resiliency, embodiments taught herein enable considerable remote storage and potable water production at the distal end of the regional potable water distribution network 74. This means that there is less community demand for potable water that otherwise must be met using primary potable water 76 produced by the regional WTP 70. Lower demand for primary potable water from the regional WTP 70 means lower annual withdrawal from the primary source water body 92, which is particularly important if short or long term drought conditions reduce the available water in the source water body 92. Communities with stormponds 40 have a supplemental source of non-potable water that could be used by communities or regional potable water providers as a source for producing a secondary potable water supply as a hedge against the instantiation of water use restrictions in the face of drought conditions.

Strategies may be utilized for proactively managing the volume of water in a stormpond so that maximum active storage volume would be available at times of the year when rainfall is abundant. At other times of the year, when large runoff volume storm events are rare, a stormpond may be proactively managed to retain as much stormwater volume as possible to maximize the available water volume for delivery to the community potable water treatment system 50.

Proactive management may be accomplished in embodiments through the implementation of monitoring and control systems accompanied by valves, pumps and other such appurtenances that can be remotely or directly operated by operations and maintenance staff.

By way of example, consider a hypothetical 100 ha community 10 having precipitation 11 of about 400 mm annually, the total annual volume of stormwater falling on the community 10 being about 400,000 m³. Prior to developing the community 10, about 10% of the annual precipitation volume would have run off to the river 92 resulting in a pre-development net positive 40,000 m³ stormwater contribution to the river 92.

After developing the community 10, the increase in community hard surfaces 30 causes about 50% of the annual precipitation volume, about 200,000 m³, to flow into the stormpond 40, which represents a 160,000 m³ annual increase in runoff over the pre-development condition.

Hypothetically, a regional development agreement for the developer of the community 10 requires that the total stormwater volume discharged 78 to the regional stormwater collection network is no more than 40,000 m³, i.e. the predevelopment runoff volume. If the community 10 developer were to use prior art practices to create absorbent landscapes and irrigation systems 38, it may result in an approximate $15 million capital cost to reduce by 160,000 m³ the annual volume of stormwater leaving the storm pond 40 via an existing storm pond outlet 44.

In contrast, disposing of 160,000 m³ of stormwater using embodiments taught herein, may require constructing a community water treatment system 50 in a small building 51 with a total capital cost of less than $2 million. Hypothetically, the proposed community 10 has a population base of 6000 people that requires the annual delivery 76 of 500,000 m³ of potable water from the regional potable water distribution network 74 with a return flow 84 of 450,000 m³ to the regional sanitary collection network 86.

Unlike the use of the much more expensive prior art source control practices, embodiments taught herein achieve the same goal of reducing stormwater runoff to pre-development conditions with the added benefit of reducing the annual volume of potable water delivered 76 to the community 10 by the regional potable water distribution network 74 to 340,000 m³ from 500,000 m³, since 160,00 m³ of community 10 annual potable water demand is supplied from stormpond 40.

When considering the greater impact of a community 10 on the river 92, the prior art source control practice results in a 10,000 m³ net annual river 92 water deficit, i.e., 500,000 m³ potable water, delivered 76 from the regional potable water distribution network 74, 40,000 m³ returned 78 to the regional stormwater collection network 80 and 450,000 m³ returned 84 to the regional sanitary water collection network 86.

In contrast, embodiments taught herein result in a 150,000 m³ net annual river 92 water surplus, i.e. 340,000 m³ potable water delivered 76 from the regional potable water distribution network 74, 40,000 m³ returned 78 to the regional stormwater collection network 80 and 450,000 m³ returned 84 to the regional sanitary water collection network 86).

From a life cycle cost perspective, the prior art source control practices would result in an annual maintenance cost of perhaps about 10% of the capital cost, whereas the cost to operate embodiments taught herein would be offset, or perhaps exceeded, by the revenue generated by the system since the produced potable water is a saleable product.

Scaling the above hypothetical scenario to a relatively modest metropolitan area with a population of about 600,000 and comprised of 100 communities, each community with a developed area of about 100 ha, the prior art approach could cost $1.5 billion and result in 1 million fewer m³ of water in the river 92 annually.

In contrast, the same metropolitan area could spend approximately $200 million on revenue generating systems, according to embodiments disclosed herein, while gaining the equivalent value of approximately $1 billion worth of raw water storage and 15 million m³ more water annually available to users of the river 92, downstream from the regional WWTP 88.

1. A potable water supply system for delivering potable water to at least one community, the at least one community having a primary potable water supply and access to at least one stormpond and non-potable water collected therein, the system comprising:
a community water treatment system for treating at least a portion of the non-potable water from the stormpond for removing primary contaminants therefrom for producing a secondary potable water supply for delivery to the at least one community.

2. The potable water supply system of claim 1 further comprising:
one or more primary water analysis systems for determining at least secondary considerations of the primary potable water supply;
one or more secondary water analysis systems for determining the at least secondary considerations of the secondary potable water supply; and
at least one balancing unit to further treat the secondary potable water supply to adjust the at least secondary considerations to be substantially the same as the at least secondary considerations in the primary potable water supply.

3. The potable water system of claim 2 wherein the secondary considerations in the primary potable water supply and in the secondary potable water supply comprise one or more of hardness, pH, taste-causing constituents, odor-causing constituents, color and reactivity.

4. The community water supply system of claim 2 further comprising:
a control system for
receiving data from the primary and secondary water analysis systems;
comparing the data from the secondary water analysis system to the data for the primary water analysis system for determining a difference therebetween; and
instructing the at least one balancing unit to adjust a composition, chemistry or both of the secondary potable water supply for the difference.

5. The community water supply system of claim 1 wherein the community water treatment system comprises one or more treatment modules.

6. The community water supply system of claim 5 wherein the one or more treatment modules operate in parallel.

7. The community water supply system of claim 6 wherein each of the one or more treatment modules operates at a different flow rate.

8. The community water supply system of claim 5 wherein each of the one or more treatment modules comprises one or more upstream treatment modules and one or more downstream treatment modules.

9. The community water supply system of claim 8 wherein the one or more upstream treatment modules pre-treat the non-potable stormpond water prior to delivery to the one or more downstream treatment modules.

10. The community water supply system of claim 5 wherein each of the one or more treatment modules utilize a same treatment technology.

11. The community water supply system of claim 5 wherein each of the one or more treatment modules utilize a different treatment technology.

12. The community water supply system of claim 1 wherein the stormpond comprises one or more of oil-grit separators, biofiltration systems, and direct filtration systems for improving the quality of the non-potable water therein.

13. The community water supply system of claim 12 wherein the stormpond further comprises a granular filter bed through which non-potable water is delivered to the community water treatment system.

14. The community water supply system of claim 13 wherein the granular filter bed is sufficiently large so as not to require backwashing.

15. The community water supply system of claim 13 wherein the granular filter bed comprises:
a berm thereabout for at least semi-isolating the granular filter bed from the stormpond; and
one or more conveyance means fluidly connected between the storm pond and the granular filter bed for delivering non-potable water to the granular filter bed when a condition of the non-potable water is at or above a threshold.

16. The community water supply system of claim 15 wherein the condition of the non-potable water is the initial quality thereof.

17. The community water supply system of claim 15 wherein the condition of the non-potable water is a water surface elevation and the threshold is a low water level.

18. The community water supply system of claim 15 further comprising a control appurtenance operatively connected to the conveyance means for controlling the delivering of non-potable water therethrough when the condition of the non-potable water is at or above the threshold.

19. The community water supply system of claim 1 wherein the stormpond has a water surface elevation fluctuating over time between a low water level, a normal water level, and a high water level and wherein supplying potable water from the community water supply occurs when the water surface elevation is above the low water level.

20. A method for supplying potable water to at least one community, the at least one community having a primary potable water supply and access to at least one storm pond and non-potable water collected therein, the method comprising:
analyzing the primary potable water supply for determining at least secondary considerations therein;
treating at least a portion of the non-potable water from the storm pond for producing a secondary potable water supply;
analyzing the secondary potable water supply for determining at least secondary considerations; and
further treating the secondary potable water supply to adjust the secondary considerations to be substantially the same as the secondary considerations in the primary potable water supply.

21. The method of claim 20 wherein the community water supply system comprises a control system and a community water treatment system having at least one balancing unit, further comprising:
receiving data for the secondary considerations of the primary potable water supply and the secondary potable water supply;
comparing the data for determining a difference therebetween; and
instructing the at least one balancing unit to adjust the secondary considerations be substantially the same as the secondary considerations in the primary potable water supply.

22. The method of claim 21 wherein the community water treatment system comprises one or more treatment modules for treating the at least a portion of the non-potable water from the storm pond comprising:
treating the at least a portion of the non-potable water with the same treatment technologies in each of the one or more modules.

23. The method of claim 21 wherein the community water treatment system comprises one or more treatment modules for treating the at least a portion of the non-potable water from the storm pond comprising:
treating the at least a portion of the non-potable water with different treatment technologies in each of the one or more modules.

24. The method of claim 20 further comprising:
removing constituents of the non-potable water in the storm pond prior to treating the at least a portion of the non-potable water therefrom.

25. The method of claim 24 further comprising:
filtering the non-potable water in a granular filter bed connected to the storm pond prior to treating the at least a portion of the non-potable water therefrom.

26. The method of claim 25 further comprising:
at least semi-isolating the granular filter bed from the storm pond; and
controlling a flow of non-potable water from the storm pond to the granular filter bed when a condition of the non-potable water is at or exceeds a threshold.

27. The method of claim 26 wherein the threshold is a quality of the non-potable water.

28. The method of claim 26 wherein the threshold is a surface water elevation.

29. The method of claim 20 further comprising:
treating the at least a portion of the non-potable water from the storm pond for producing a secondary potable water supply when a surface water elevation is above a low water level.

30. A system for supplying a demand for potable water by one or more communities accessing a watershed for supplying a primary source of non-potable water for producing a primary potable water in a regional water treatment plant, the one or more communities having access to a stormwater pond collecting non-potable runoff water from at least one of the one or more communities therein, the system comprising:
drawing at least a portion of the secondary non-potable runoff water from the storm pond as a secondary source of non-potable water;
treating the at least a portion of the secondary non-potable runoff water in a community water treatment system to produce secondary potable water;
supplying the secondary potable water to the one or more communities; and
while supplying the secondary potable water,
decreasing a draw volume of primary non-potable water from the primary water source to the regional water treatment plant;
releasing at least a portion of the secondary potable water to the watershed after use by the one or more communities; and
releasing a volume of the non-potable run-off from the stormpond to the watershed at or below a threshold volume and at a rate to avoid damage thereto,
wherein the decrease in the draw volume from the primary water source, the at least a portion of the volume of the secondary potable water released to the watershed after use and the volume of non-potable water released from the stormpond to the watershed results in from a zero to net surplus of water in the watershed.

31. The system of claim 30, wherein the threshold volume is a pre-development volume.
